(19) United States
(12) Patent Application Publication
(10) Pub. No.: US 2015/0308615 A1
(43) Pub. Date: Oct. 29, 2015

(54) Bed-Mounted Pet Feeder with Adjustable Stand

(71) Applicant: Evan R Neaves, Middletown, DE (US)

(72) Inventor: Evan R Neaves, Middletown, DE (US)

(21) Appl. No.: 14/265,326

(22) Filed: Apr. 29, 2014

(51) Int. Cl. F16M 13/02; A01K 5/01

(52) U.S. Cl. CPC F16M 13/022; A01K 5/0114

(57) ABSTRACT

The invention provides a bed-mounted pet feeder that allows pet owners to have their pet's food and/or water dish mounted to a person's bed via box spring, footboard, bed post, or bed frame, so that their pets can easily access their food or water while still on the person's bed. The adjustable mounting mechanism allows the feeder to be mounted to the bed in a variety of ways, alleviating the need for pet owners to have to take their pets off the bed in the middle of the night or for their pets to go hungry or thirsty while their owners are sleeping. The adjustable stand also accommodates the many shapes and sizes of pets, allowing them to easily eat or drink whether they are standing or sitting on the bed. The bowls fit securely in the stand and create stability as the pet eats or drinks, reducing the risk of spilling on the bed.

### BACKGROUND

Pets and their humans often prefer to share the same bed at night. However, many of these pets also feel the need to leave their human's bed periodically during the night to get something to drink or eat. In some cases, this is merely disruptive to their human's good night sleep. In other cases, however, jumping up and down from the height of a human bed could be harmful, painful, medically inadvisable, or outright impossible for the pet. Smaller dogs might injure themselves attempting to jump from a height. Older dogs with arthritic inflammation or dogs with hip dysplasia might find getting down from a human bed to be painful or physically impossible without assistance. Some breeds, particularly the chondrodystrophic breeds, are prone to intervertebral disk disease. These breeds can cause themselves serious injury or aggravate preexisting conditions by attempting to jump up or down from even a relatively small height. Similarly, dogs with vision problems may find it difficult to get up and down from the height of a bed without assistance. Most of these pets cannot safely navigate steps designed for pets or should not attempt to do so. Regardless of the reason, it is highly desirous for a pet to not attempt to jump up and down from a human's bed at night.

A number of elevated pet feeders have been described in the art. For example, D682,485 provides a pet bowl and stand that raises the bowl a few inches off of the floor. D676,612 provides a similar pet bowl, attached to a low pet bed. Other elevated pet bowls known in the art include D669,231 and D667,175, each of which are similarly designed to elevate the pet bowl a small amount off of the floor. A more elaborate elevated pet feeder is shown in U.S. Pat. No. 8,516,975. Each of these, however, are designed to sit on the floor and each of them only raises the height of the bowl so that the animal can eat or drink more comfortably while standing on the floor. An adjustable wall-mounted pet feeder is described, for example, in U.S. Pat. No. 5,000,124, but this too is designed to provide an elevated feeding platform for a pet standing on the floor.

### SUMMARY OF THE INVENTION

Although elevated pet feeders are known, none of these products address the need to provide a source of food and/or water to a pet while it is on a human's bed. Existing elevated feeders are not stable enough to sit securely on a bed nor can they be adjusted to a height sufficient to reach the bed. Neither are they designed to position a source of food or water above and over a bed so that a pet can comfortably and safely reach food or water.

The present invention addresses these and other needs, by providing a pet feeder that mounts to the bed itself. The invention provides a bed-mounted pet feeder comprising: a top, an adjustable stand, and a base, where the base is generally configured to securely mount to one or more portions of a human bed, such as the bed frame, side rail, bed post, and/or the box spring.

The top generally has an upper surface, a lower surface, and a bowl region. In some embodiments, the top may have a plurality of bowl regions. Optionally, the bed-mounted pet-feeder may also include one or more pet dishes. According to certain embodiments, the top may also be rotatably attached to the adjustable stand.

The bowl region of the top may comprise an aperture running from the upper surface of the top through to the bottom surface of the top, where the aperture is configured to hold a pet dish. Alternately, the bowl region may simply be a recessed region on the upper surface of the top that is adapted to contain a pet dish, where the recess divides the top surface into a raised peripheral region and a recessed central region. The upper surface of the top may also contain a raised edge to help contain spills.

The adjustable stand of the bed-mounted pet feeder has an upper end and a lower end, where the upper end is attached to the top and the lower end is attached to the base. The adjustable stand itself is comprised of an upper stand section, a lower stand section, and a fastening mechanism. The upper stand section and the lower stand section are telescopically connected. The fastening mechanism is attached to the stand and is capable of maintaining the adjustable stand at a chosen height. Fastening mechanisms may include, for example, a compression fitting, clamp, screw, bolt, peg, snap button, quick-release button connector, pin, pull pins, linch pin, clevis pin, gravity pin, and locking pin.

According to certain embodiments, the bed-mounted pet feeder may further comprise a horizontal member having a proximal end and a distal end, where the proximal end is connected to the adjustable stand and extends out from the stand in the horizontal direction, with the distal end being configured to be retained between a box spring and a mattress. The horizontal member may, for example, be attached to a vertical slot in the stand such that the slot allows the height of the horizontal member to be adjusted.

In another embodiment, the bed-mounted pet feeder includes a stand with a clamping mechanism that attaches to the box spring of a bed. One or more bowls may be attached to the stand in a manner that helps prevent food or water from spilling directly on the bed. The stand is configured so that the height of the bowls may be adjusted to accommodate different mattress heights and different sized pets.

In another embodiment, the base includes a bracket configured to mount to a side rail of a bed. In this embodiment, the bracket comprises an outer vertical face, an upper horizontal face, and an inner vertical face.

In another embodiment, the base of the bed-mounted pet feeder may include a horizontal and a vertical portion that defines a vertical channel configured to fit over a side rail or the vertical portion of a bed frame. The base may also include a second horizontal portion configured to fit over a horizontal portion of a bed frame and/or underneath a box spring. The base may also include a tensioning screw, such as a threaded screw, configured to tighten the base against a vertical surface on a side rail or bed frame.

According to certain embodiments, where the base comprises a clamping mechanism, the clamp may comprise a bracket having a first end a second end, where the first end of the bracket is rotatably attached to a lower surface of the base, and the second end of the bracket has a threaded screw that can be tightened against the bed frame, thereby clamping the base to the bed frame.

The invention also provides a bed-mounted pet feeder where the base comprises a vertical portion capable of being positioned between a vertical portion of a bed frame and a side of a box spring, and a horizontal portion capable of being positioned between the horizontal portion of the bed frame and the bottom of the box spring.

The invention also provides a bed-mounted pet feeder having a base with a removable bracket configured to be mounted to a bed frame or a side rail of a bed.

### BRIEF DESCRIPTION OF THE DRAWINGS

FIG. 1 is an isometric perspective view according to an illustrative embodiment of the invention.

FIG. 2 is a side view, in cross-section, of the embodiment shown in FIG. 1.

FIG. 3 is a focused front view of the base from the embodiment shown in FIG. 1.

FIG. 4 is focused side view of the base of the embodiment shown in FIG. 1.

FIG. 5 is top view of the base of the embodiment shown in FIG. 1, in isolation.

FIG. 6 is a bottom plan view of the base of the embodiment shown in FIG. 1.

FIG. 7 is an isometric perspective view of another illustrative embodiment of the invention, featuring two pet bowls attached to an adjustable stand and clamping mechanism that allows it to be attached to a box spring.

FIG. 8 is a top view of FIG. 7.

FIG. 9 is a bottom plan view of FIG. 7.

FIG. 10 is a front-side elevational view of FIG. 7.

FIG. 11 is an isometric perspective view of another illustrative embodiment of the invention, featuring a base configured to mount to the side rail of a bed.

FIG. 12 is back elevation view of the embodiment shown in FIG. 11.

FIG. 13 is focused side cross-sectional view of the embodiment shown in FIG. 11.

FIG. 14 is focused exploded isometric view another illustrative embodiment of the invention, featuring a removable and reversible mounting bracket.

FIG. 15 is cross-sectional view of the embodiment shown in FIG. 14.

FIG. 16 is cross-sectional view of the embodiment shown in FIG. 14, with the bracket mounted in the reverse orientation.

FIG. 17 is a focused isometric perspective view of an illustrative embodiment of a semi-universal base for mounting onto a bed frame or side rail.

FIG. 18 is a focused side view of the embodiment of FIG. 17.

FIG. 19 is a bottom view of the embodiment of FIG. 17.

### DETAILED DESCRIPTION

The bed-mounted pet feeder disclosed herein addresses an unappreciated need to provide food and/or water to a pet while it remains on a person's bed. Although various forms of elevated pet dishes have been described, none of them contain the unique combination of features contained in the bed-mounted pet feeder of the present invention.

Prior art pet feeders are poorly suited to the task of providing food and/or water to a pet while it remains on a person's bed. As one will readily appreciate, simply placing a regular elevated or non-elevated pet dish on a bed is not a realistic option. Mattresses and blankets shift during the night and a regular pet dish could easily be kicked over or knocked off the bed by either the pet or the person sleeping in the bed.

Wall mounted pet feeders are designed to feed a pet standing on the floor and are also a poorly suited to providing food and/or water to a pet on a human bed. Even if a wall-mounted feeder could be mounted high enough for a pet to reach from a bed, it would require that the bed be placed against the wall itself. Otherwise, the pet would be required to lean out over the edge of the bed, possibly risking a fall. Such a wall-mounted pet feeder would also be awkward to reach to fill and clean, since the bed would have to be pushed against the wall having the feeder.

Floor standing pet feeders are not nearly tall enough to provide food and/or water to a pet on top of a person's bed. Even if one were to modify a floor standing pet feeder to make one tall enough, it would become unstable—particularly if it were also designed to hold a food and/or water dish over the mattress so that the pet does not risk falling off the bed when it eats or drinks Thus, floor standing pet feeders too are poorly suited to fit the task of providing food and/or water to a pet while it remains on a human bed.

The bed-mounted pet feeder as disclosed herein fills this need in the art by providing a stable eating and/or drinking platform that has a base that is anchored to one or more parts of the bed itself, such as the bed frame, the side rail, the footboard, the bed post, and/or the box spring. Additional stability is optionally provided by horizontal member that is attached to the stand of the bed-mounted pet feeder and sits between the mattress and box spring, held in place by the weight of the mattress and friction. These mounting structures provide the stability necessary to hold a pet dish (or dishes) over the mattress in a manner so that the pet does not have to lean out beyond where it has stable footing at the edge of the bed. This can be particularly important, as many of the pets that the bed-mounted pet feeder of the present invention is designed to serve happen to have mobility issues, putting them at risk for a fall if they were to try and lean out to reach a feeder.

Because the bed-mounted pet feeder of the invention is mounted to the bed itself, the presence of the feeder does not unreasonably restrict the placement of the bed within a room. Moreover, since the feeder is mounted to the bed itself, the feeder can be place in a location on the bed that is easy to reach, making it easy to fill and clean.

The top of the feeder may be a structure largely horizontal in overall profile, having any shape suitable for holding one or more pet dishes, such as square, rectangular, trapezoidal, round, or ovoid. The top may be sized to accommodate one, two, or a plurality of pet dishes. Similarly, the pet dishes themselves may be of any suitable shape. Corners on either the top or the dishes themselves may be rounded to reduce the chance of injury or damage to other furniture, pets, or humans. Optionally, the top may also have a raised outer edge to help contain spilled food or water.

The top is attached to a stand. Preferably, the top is attached to the stand in such a manner that the pet dish is positioned at least partially over the mattress of the bed. In this way, the pet is not forced to stand on the very edge of the bed as it eats or drinks. In accordance with certain embodiments of the invention, the top may be attached to the stand such that some, at least about half of the top, or more is positioned over the mattress. In certain embodiments of the present invention, the top is also attached to the stand in a manner that allows the top to be rotated and/or locked in place, such as by a thumb screw that can be tightened or by any other suitable mechanism. This allows the top to be rotated out of the way for entry and exit from the bed and also facilitates the cleaning and filling of the feeder.

The pet dish or dishes may sit on the upper surface of the top, within a recess configured to accommodate a pet dish, or within an aperture through the top that has been sized and configured to accommodate the pet dish. The pet dish may be composed of any suitable material or combination of materials, such as stainless steel, aluminum, rubber, plastic, or glass and may or may not be composed of the same material as the top.

Mattress thicknesses generally range from about four to about eighteen inches in depth. Although not always used, box springs generally range from about five to about nine inches. Consequently, a standard low mattress and box spring combination may be only about nine inches in height, whereas a taller modern box spring and mattress set can be twenty-seven inches or more. Mattress pads and bedding may add additional overall height to a bed.

Pets too, vary in size and thus different pets may require a pet dish at different heights above the bed. Consequently, the bed-mounted pet feeder may be configured to provide the pet dish at a suitable eating or drinking height for a pet sitting or standing on a bed. Depending on the size of the pet, a suitable elevation may be anywhere from just above the bedding up to 15 inches or more above the top of the bed.

The bed-mounted pet feeder of the present invention addresses these issues by having a telescopically adjustable stand. Once the stand is adjusted to the desired height, a locking mechanism is used to secure the stand at the chosen height. Any mechanism suitable for locking a telescopically extending stand may be used. Suitable locking mechanisms include, but are not limited to, compression fittings, clamps, screws, bolts, pegs, snap buttons, quick-release button connectors, pins such as pull pins, linch pins, clevis pins, gravity pins, locking pins, and the like. In accordance with those embodiments in which the locking mechanism is a screw, bolt, peg, snap button, quick-release button connector, or type of pin, the telescoping stand sections may also comprise one or more apertures. Apertures are sized and positioned to accommodate insertion of the chosen locking mechanism through aligned apertures, thereby securing the stand at a desired height. Thus, the bed-mounted pet feeder may be configured to have an overall height from about 6 to about 40 inches or more. Typically, however, the bed-mounted pet feeder of the invention will be at least 15, at least 20, at least 30 or at least 40 inches in overall height.

Different beds also have different constructions and thus a variety of methods for mounting the pet feeder onto a person's bed are contemplated and fully within the scope of the invention including, but not limited to mounting to the metal frame of the bed, the side rail, the footboard, the bed post, and/or the box spring.

Metal bed frames are generally formed using angle iron stock that has an “L-shaped” cross section. In other words, the frame has vertical portion and a horizontal portion. Common dimensions for the vertical and horizontal portions of the bed frame angle iron generally range from about 1 to about 4 inches. Common dimensions are about 1, 1¼, 1⅜, 1½, 1¾, or 2 inches. Depending on the design, horizontal and vertical portions of the bed frame may have the same or different dimensions. In most cases, the bed frame is designed the mattress or box spring sits between the vertical portions of the frame and rests on the horizontal portions of the bed frame. That is not universally true, however, and some bed frames have the opposite orientation with the mattress or box spring sitting on the horizontal portion of the bed frame and the vertical portion of the bed frame positioned below. In these types of bed frames, other means are used to keep the mattress or box spring properly positioned.

Thus, in accordance with the invention, for those embodiments having a bed frame mount, the base or a bracket attached to the base of the bed-mounted pet feeder generally has a portion that is configured to conform to the L-shape of the metal frame, fitting between the bed frame and the box spring or mattress. The base or bracket attached to the base may be configured so that it sits between frame and box spring on the bottom and side, held in place by the weight of the bed. Alternatively, the base or bracket may be held in place by screws, bolts and/or a clamping mechanism that can be tightened to firmly attach it to bed frame. In certain embodiments, the bracket or portion of the base may be reversible, so as to accommodate bed frames having the vertical portion of the frame pointing upwards or downwards.

In certain embodiments of the present invention, the bed-mounted pet feeder contains a base that is configured to mount to the side rail of a bed. Generally, the side rail mount comprises a base having a portion or attached bracket that wraps around the inner face, the top, and the outer face of the side rail. The side rail mount may also include a clamping mechanism, shims, or other means for adjusting the mount to accommodate side rails of varying thicknesses or widths.

In other embodiments of the present invention, the bed-mounted pet feeder contains a base that is configured to mount to a bed post or footboard. The bed post mount generally comprises a bracket that either wraps around the circumference of the bed post and is tightened in place or a bracket that is screwed or bolted into the side of the bed post. Depending on the configuration of the footboard, footboard mounts may comprise a bracket that is screwed or bolted onto the footboard or in the case of simpler footboards, slip over the top of the footboard in a manner analogous to the side rail mount.

For additional stability, in addition to having a base that is mounted to the bed frame, the side rail, footboard, or bed post, the bed-mounted pet feeder of the present invention may also optionally contain a horizontal member that is attached to the stand and extends outward horizontally to fit between a mattress and a box spring. The upper and/or lower surface of the horizontal member can further comprise a surface treatment suitable to increase the friction between the horizontal member and the box spring and/or mattress. Suitable surface treatments include, for example, cloth, Velcro, or rubber. Alternatively or in addition, the upper and/or lower surface of the horizontal member may be embossed or textured, such as with cross-hatches, bumps, ridges, and the like.

The horizontal member is attached to the stand in manner that allows its vertical position to be adjusted. This allows positioning to accommodate various mounting methods and differing box spring heights. Any suitable mounting method may be used including, for example, one or more apertures or slots in the stand where the horizontal member has a bolt that can be positioned within the aperture or slot and then tightened at a chosen height, a bracket or clamp that can attach to the stand and be tightened at a chosen height, and the like.

The bed-mounted pet feeder of the present invention may be composed of any suitable material or combinations of materials, or stained or painted in any desired color or combination of colors. Suitable materials include, for example, wood (such as pine, spruce, birch, maple, oak, or mahogany), composite board, wood laminate, metal (such as aluminum, iron, steel, base metal, or brass), or plastic (such as nylon, polyethylene, polypropylene, and polystyrene). Thus, the bed-mounted pet feeder of the invention may advantageously be constructed of materials designed to match regular bedroom furniture.

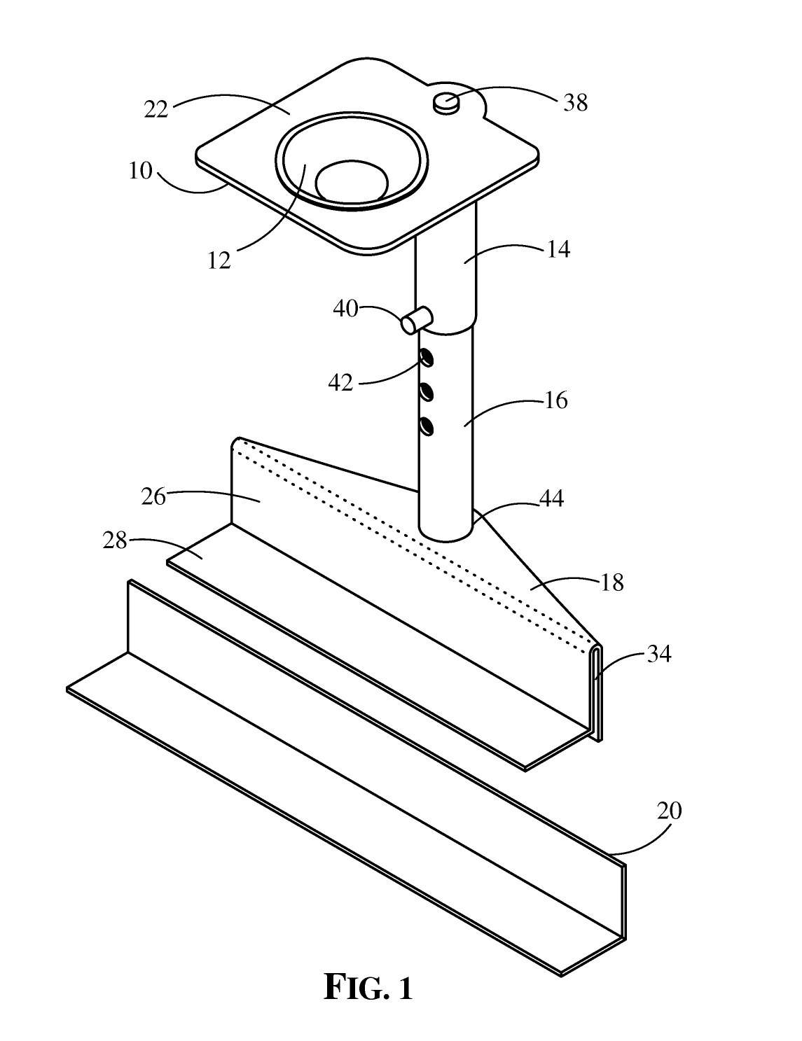

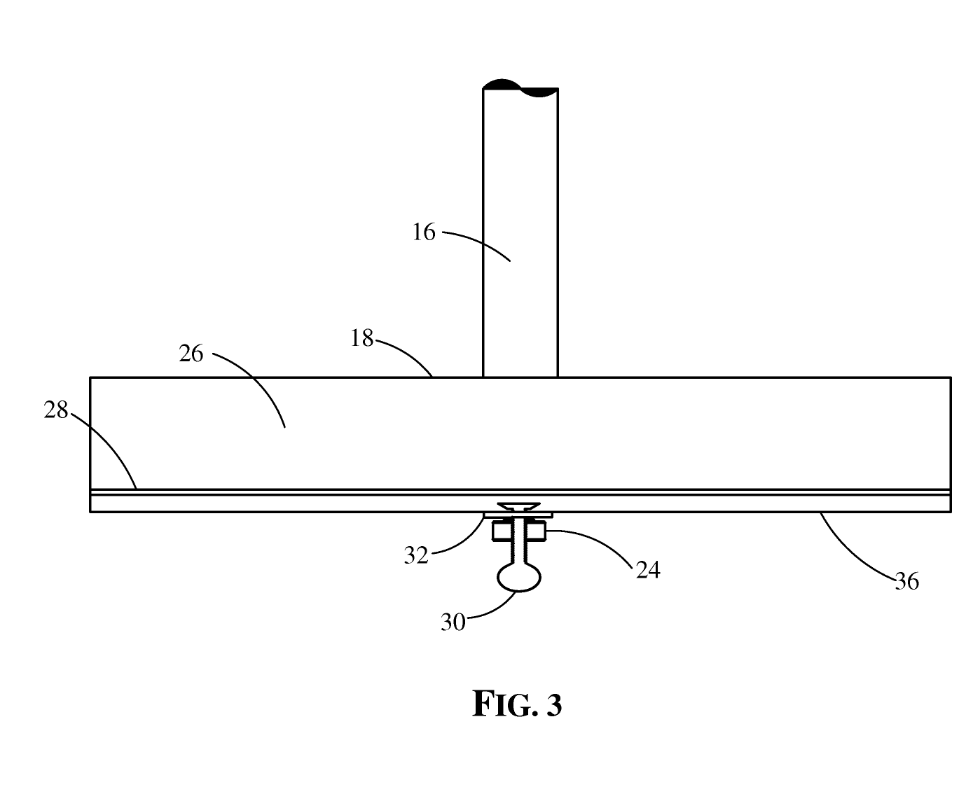

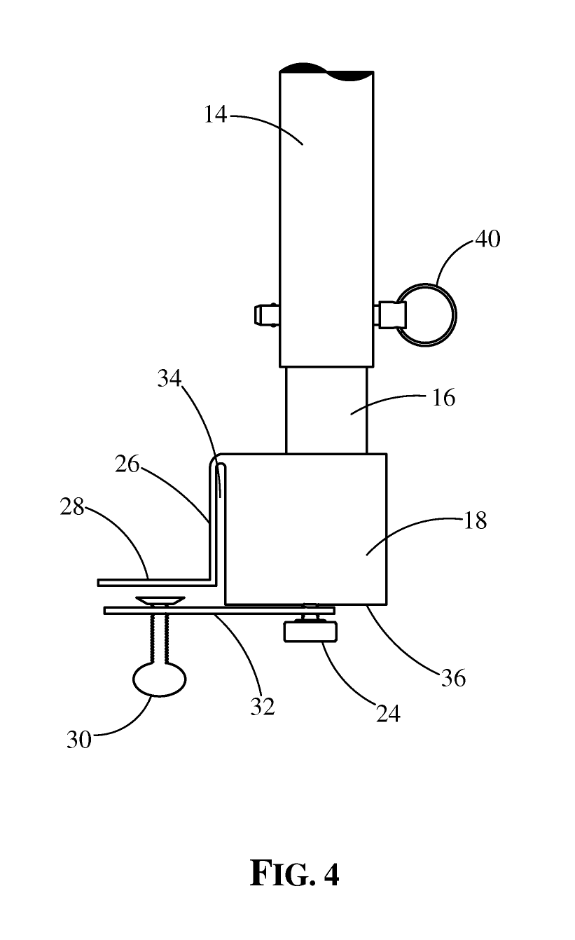

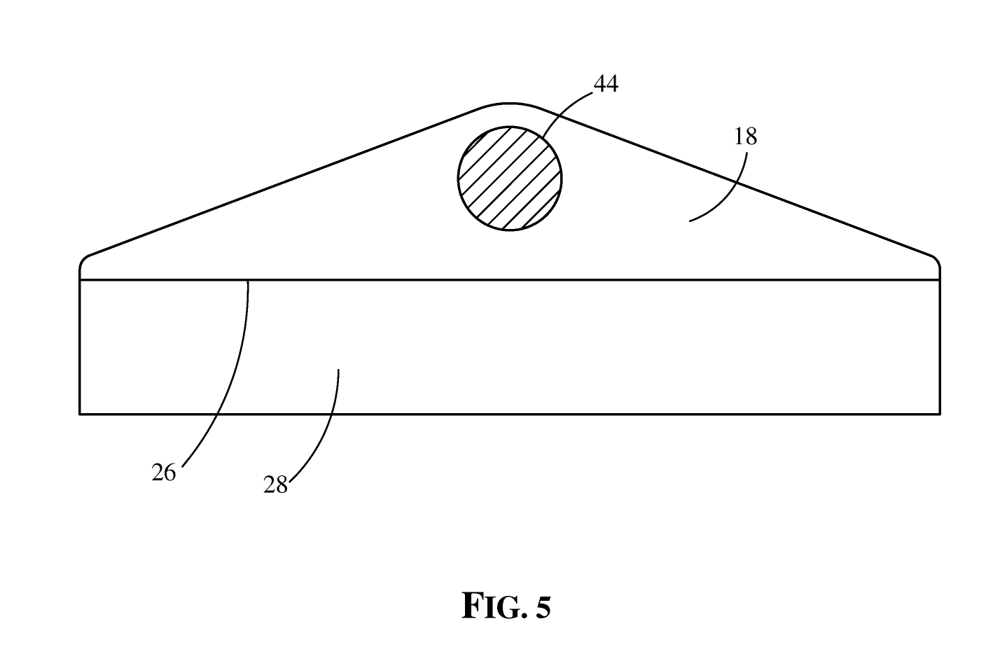

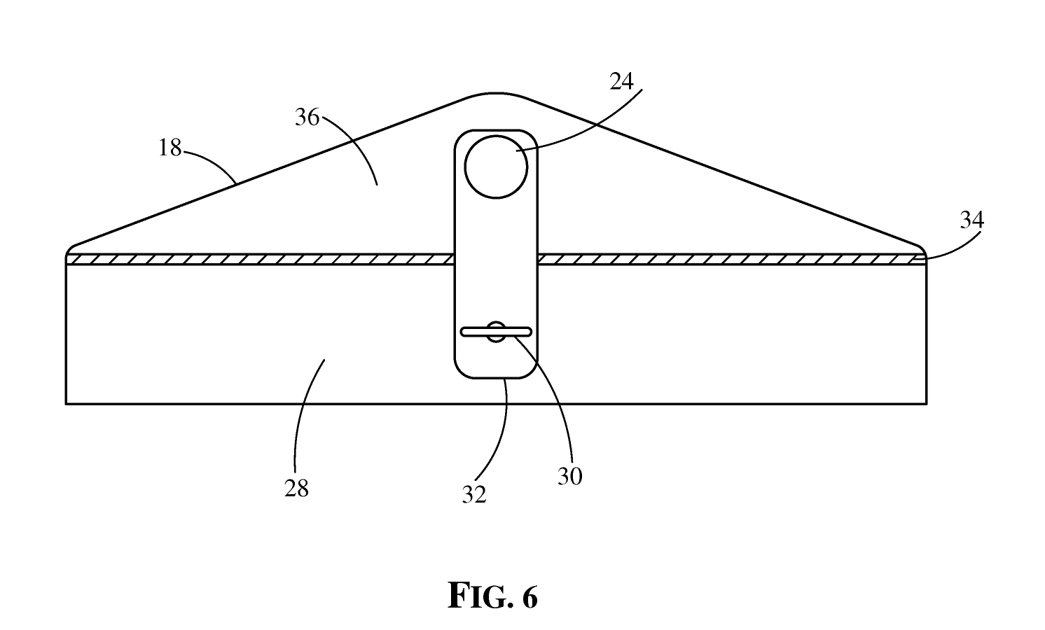

The present invention may be more readily understood by reference to certain illustrative embodiments set forth in the figures. Turning to FIGS. 1-6, an illustrative embodiment of the bed-mounted pet feeder of the invention is shown. The bed-mounted pet feeder comprises a top 10 that is sized and configured to hold a pet dish 12, a support system that includes an upper support member 14 and a lower support member 16, and a bed mounting assembly 18 for attachment to the frame of a bed 20.

As noted above, the top 10 may be any shape suitable for holding a pet dish such as square, rectangular, trapezoidal, round, ovoid, or irregularly shaped. Here, a top having the shape of an irregular rectangle is shown. Corners are rounded to reduce the chance of injury or damage to other furniture, pets, and humans. The top 10 holds a pet dish 12. A single pet dish is shown in the figures, although the top may be sized to accommodate one, two, or a plurality of pet dishes. The top is mounted on the stand in such a manner that the pet dish is positioned over the mattress of the bed.

As pictured, the pet dish 12 sits securely within an aperture that is sized and configured to accommodate the pet dish. Again, as noted above, in other embodiments the pet dish may also sit on upper surface of the top 22 or within one or more recesses in the top 10 that have been sized and configured to accommodate the pet dish 12. Optionally, the top may also include a raised edge to help contain spills.

The top 10 is connected to a stand assembly that is telescopically adjustable in height. The stand assembly is comprised of an upper stand section 14, a lower stand section 16, and a fastening mechanism 40. The upper stand section 14 is connected to the top 10 in a fixed or rotatable manner such as by a thumb screw 38. Rotatable attachment may be advantageously used so that the top 10 can be rotated out of the way and to facilitate adding food or water to the dish.

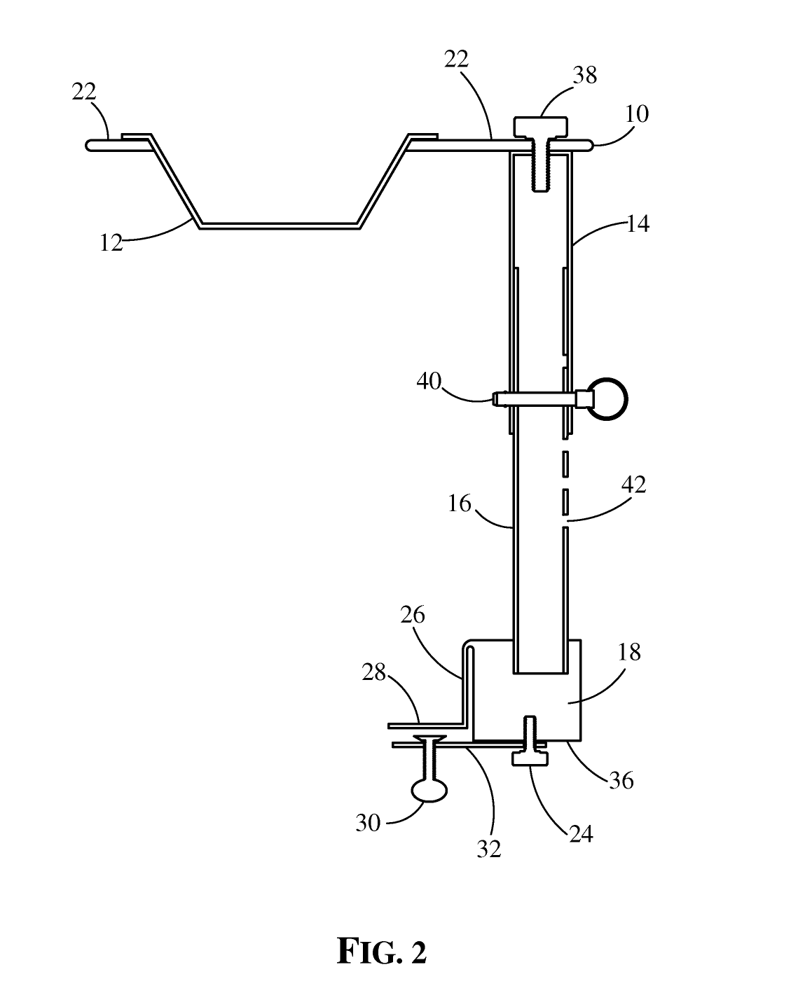

The upper stand section 14 and the lower stand section 16 are releasably and telescopically connected to one another in a manner that allows for adjusting the height of the stand and thus, the overall height of the bed-mounted pet feeder. Thus, the stand includes a fastening mechanism 40 to maintain the stand at a desired height. Although FIGS. 1 and 2 show a pin being used as a fastening mechanism, any suitable fastening mechanism may be used. Suitable fastening mechanisms include but are not limited to compression fittings, clamps, screws, bolts, pegs, snap buttons, quick-release button connectors, pins such as pull pins, linch pins, clevis pins, gravity pins, and locking pins, and the like. Depending on the fastening mechanism being utilized, the upper stand section 14, the lower stand section 16, or both, may also comprise one or more apertures 42. Apertures are sized and positioned to accommodate insertion of the chosen fastening mechanism through aligned apertures, thereby securing the stand at a desired height.

The telescoping stand is affixed to a base 18 that is configured to sit over the metal L-shaped bar of a typical bed frame 20. Thus, the base has a portion to which the telescoping stand is attached 44, a vertically extending channel 34 configured to engage the vertical portion of the bed frame 20, a vertical portion 26 that is configured to be able to sit on the inner side of the bed frame 20 between the bed frame and the box spring or mattress. The base may also have a horizontal portion 28 that is configured to be able to sit on top of the upper surface of the bed frame 20 between the bed frame and the box spring or mattress.

A bracket 32 is attached to a bottom surface of the base 36 with a screw, thumb screw 24, bolt, or other suitable means. Preferably, the bracket is rotatably attached to the base, so as to allow the bracket to be swung out of the way when the base is placed on the bed frame. After placement of the base on the bed frame, the bracket 32 can be swung back into place and the screw 24 can be tightened, preventing the pet feeder from accidentally being displaced from the bed. Alternatively, the bracket 32 can simply be mounted on the bottom surface of the base 36 after placement of the unit onto the bed frame. At the other end of bracket 32, sitting underneath the horizontal portion of the base 28, bracket 32 may also have a screw, clamp or other similar mechanism 30 that can be tightened against the horizontal portion of the bed frame, further securing the bed-mounted pet feeder to the bed frame.

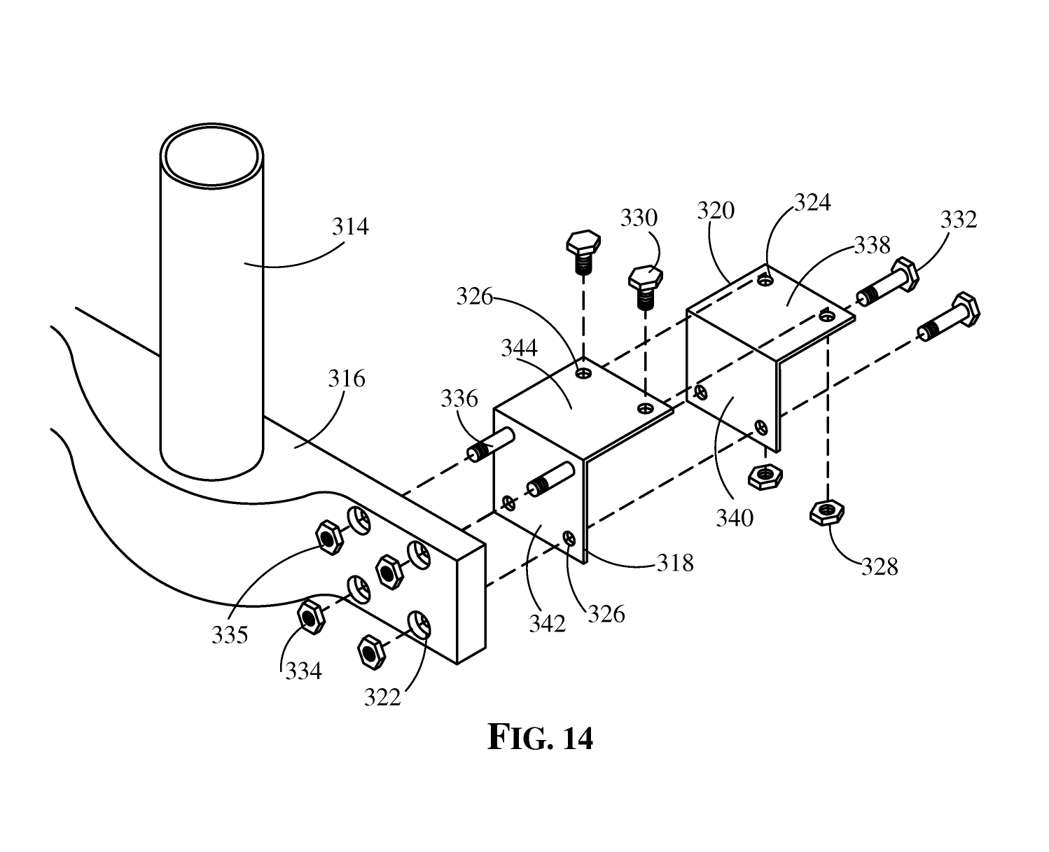

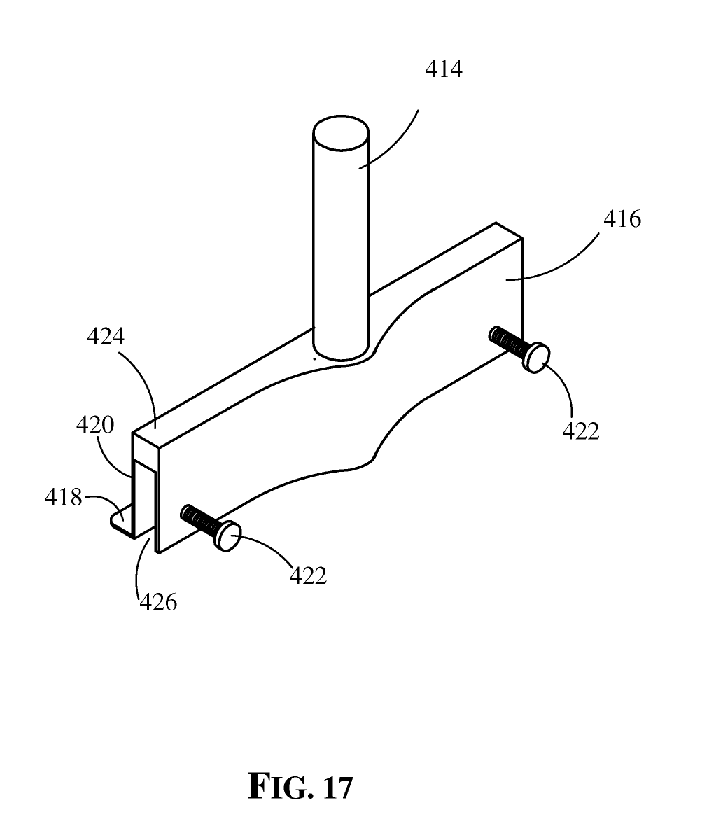

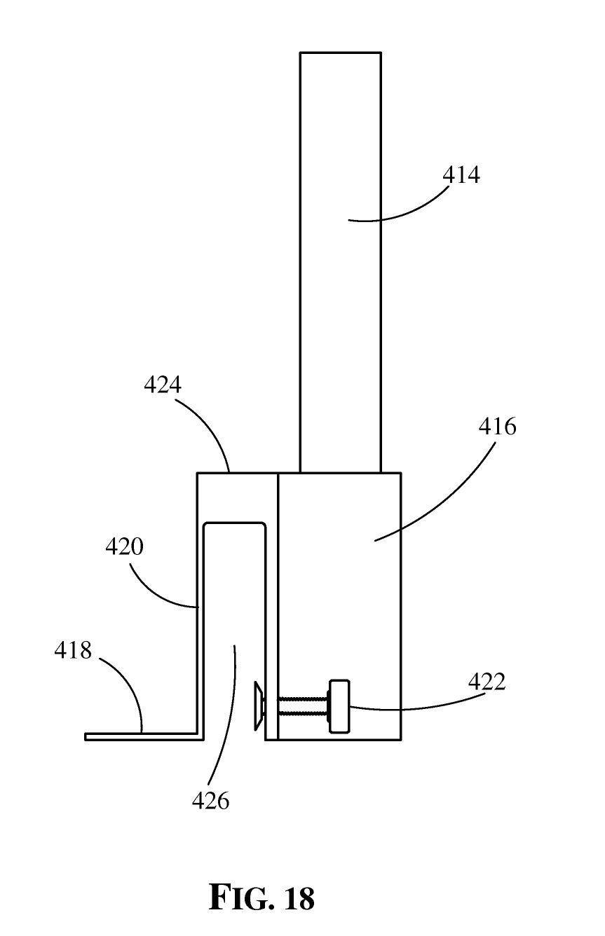

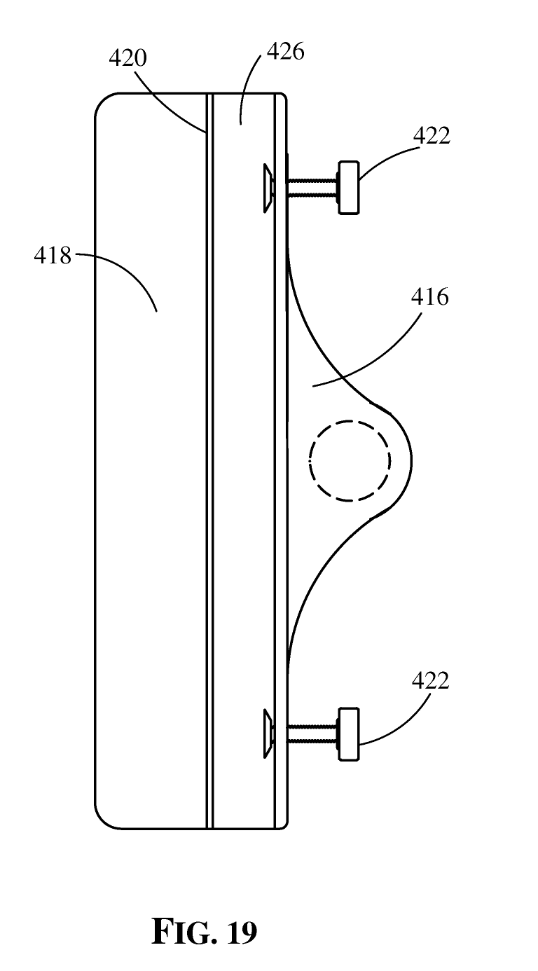

Alternatively, instead of the pictured clamping mechanism 30, the horizontal portion of the base 28 and the bracket 32 may be configured to extend beyond the bed frame so that they may be bolted together, thereby securely mounting the base to the frame of the bed (analogous to the embodiment depicted in FIGS. 14-16). Also not pictured, the base may be configured to clamp onto the vertical portion of the bed frame, with or without the horizontal portion 28, in a manner analogous to the embodiment depicted in FIGS. 17-19.

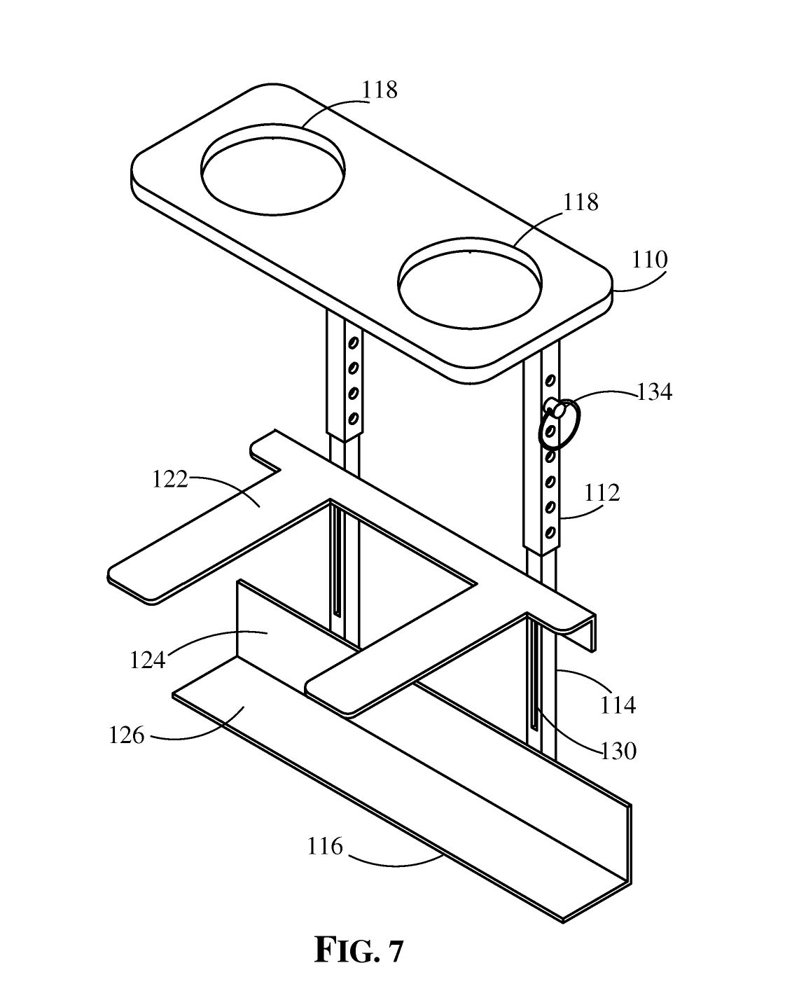

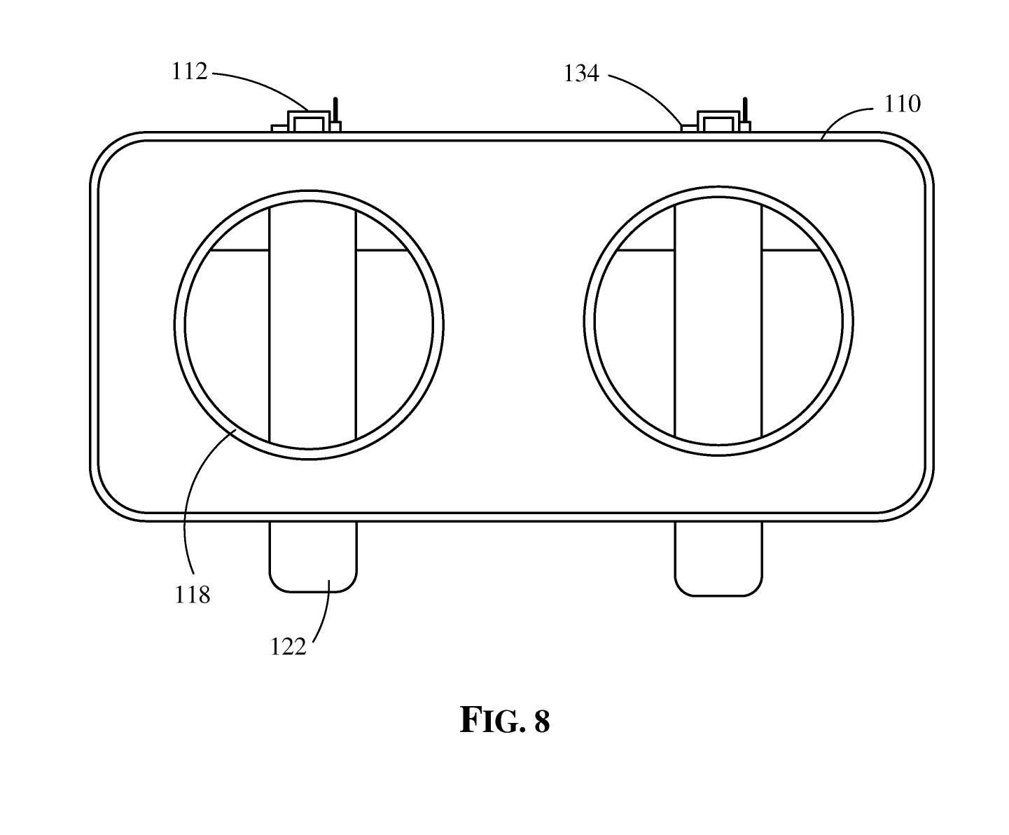

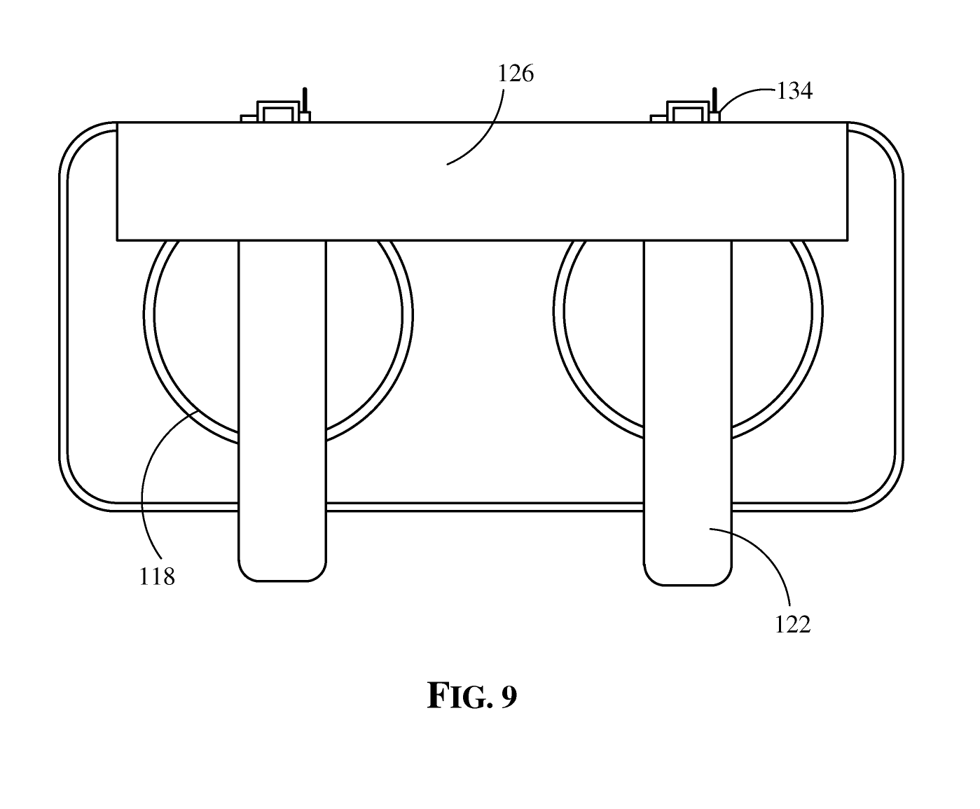

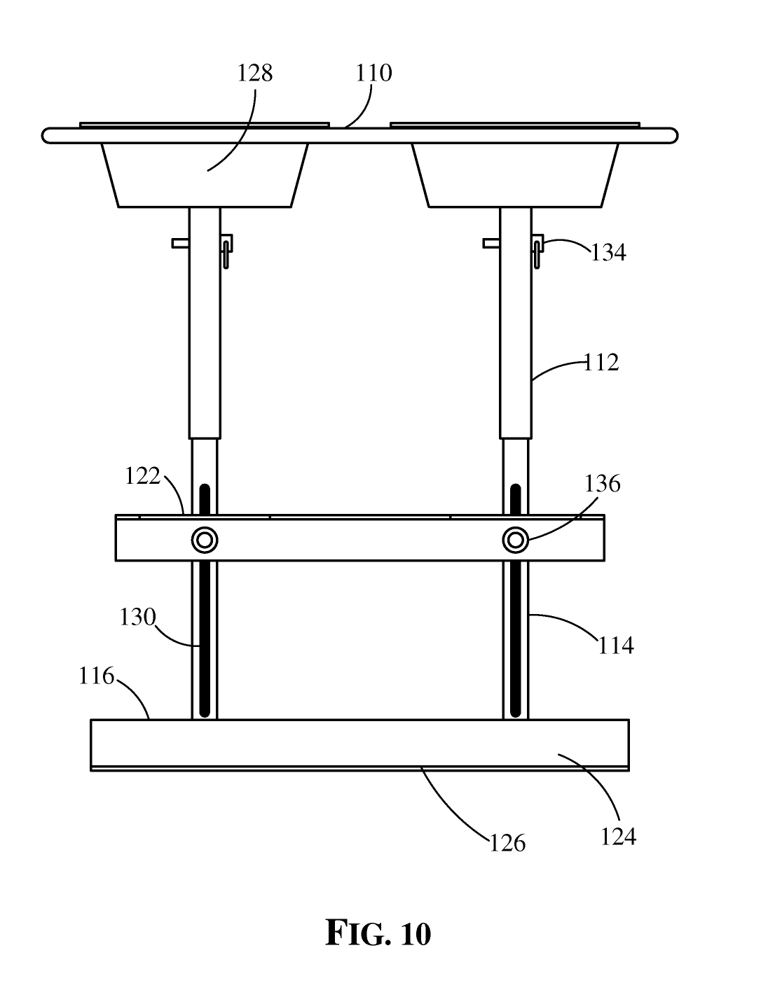

In further embodiments of the invention, the bed-mounted pet feeder mounts on the box spring of the bed either alone or in combination with the frame of the bed to provide stability to the feeder. For example, FIGS. 7-10 show an illustrative embodiment of the invention wherein the bed-mounted pet feeder can be mounted on the box spring. The feeder includes a top 110, a telescopically adjustable stand, and a box spring mount comprising a base 116 and a horizontal member 122.

The telescopically adjustable stand comprises an upper stand section 112, a lower stand section 114, and a locking mechanism to maintain the stand at a desired height. As drawn, the locking mechanism is a pin 134, though as with the previous illustrative embodiment, any suitable locking mechanism may be used. The upper and lower stand sections comprise one or more apertures 132. Apertures are sized and positioned to accommodate insertion of the chosen fastening mechanism through aligned apertures, thereby securing the stand at a desired height.

Attached to the lower section of the telescopically adjustable stand is a horizontally disposed member 122 that is configured to friction fit between the mattress and the box spring of a bed. By providing an additional mounting point to the bed, the horizontal member provides additional stability to the stand of the bed-mounted pet feeder. Although not shown, the upper and/or lower surface of the horizontal member 122 can further comprise a surface treatment suitable to enhance the friction between the member and the box spring and/or mattress.

As illustrated, the horizontal member 122 is attached to the lower stand section 114, via a bolt 136 that passes through a slot 130, which passes front to back through the lower stand member 114. The length of the slot 130 is configured to allow the position of the horizontal member 122 to be adjusted to accommodate box springs of differing sizes. The bolt 134 is tightened at a chosen position, thereby helping the horizontal member 122 to secure the feeder to the bed.

The telescopically adjustable stand is attached to a base 116 that is configured to generally conform to the L shaped cross-section of a bed frame. The base has a vertical portion 124 and a horizontal portion 126 connected to one another to form an L shape in cross section. The vertical portion of the base 124 is attached to the lower stand member 114. In use, the stand may be mounted so that it is on top of the bed frame, in between the frame and the box spring such that the vertical portion of the base 124 is positioned between the vertical portion of the bed frame and the side of the box spring, and the horizontal portion of the base 126 is positioned between the horizontal portion of the bed frame and the bottom of the box spring. Without intending to be bound by any particular theory, it is believed that in this configuration the weight of the mattress and box spring sitting on top of the horizontal portion of the base 126, the generally tight fit between the box spring, the base 116, and the bed frame, together with the additional support provided by the horizontal member 122, act together to provide a stable mount to the bed.

In an alternate mounting configuration, the base 116 may also be mounted outside and underneath the bed frame or box spring. In this alternate mounting configuration, moderate compression of the box spring between the horizontal member 122 and the base 116 act essentially like a clamp to hold secure the bed-mounted pet feeder to the bed. According to certain embodiments of the invention, the base 116 may be also attached to the lower stand member 114 via a threaded screw, creating a vise-like configuration between the horizontal member 122, the lower stand member 114, and the base 116.

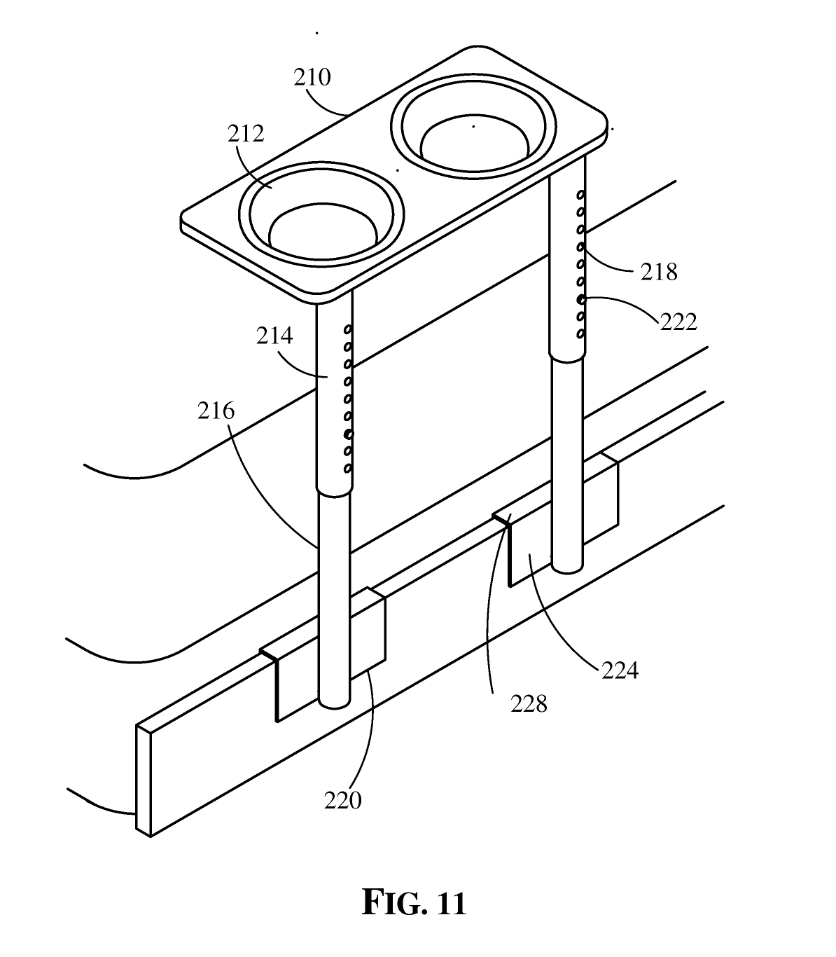

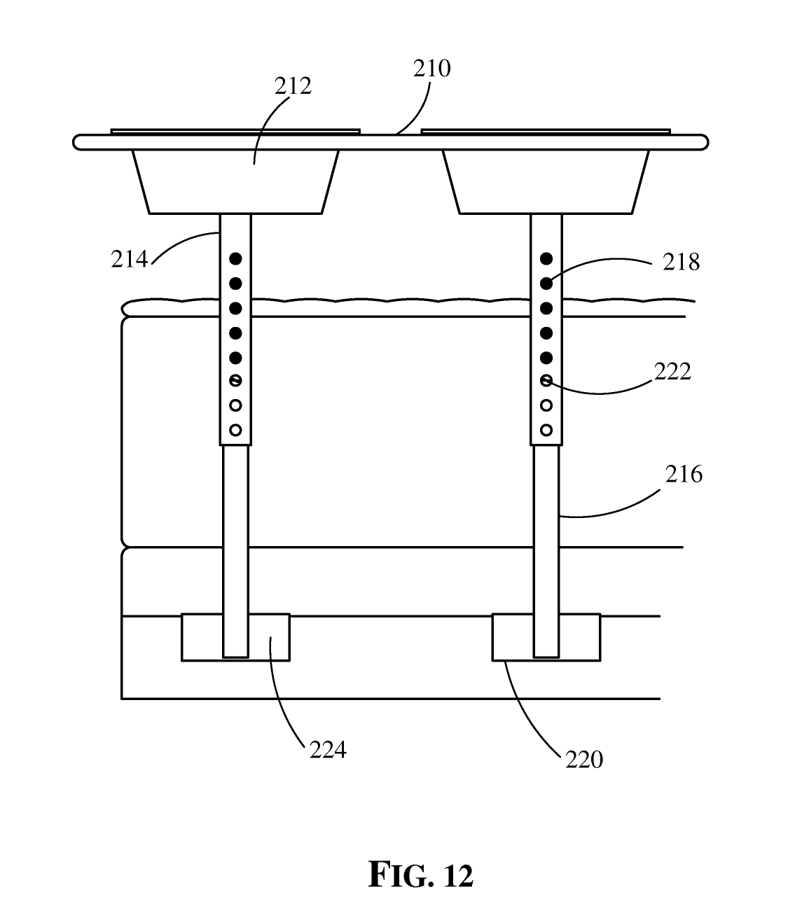

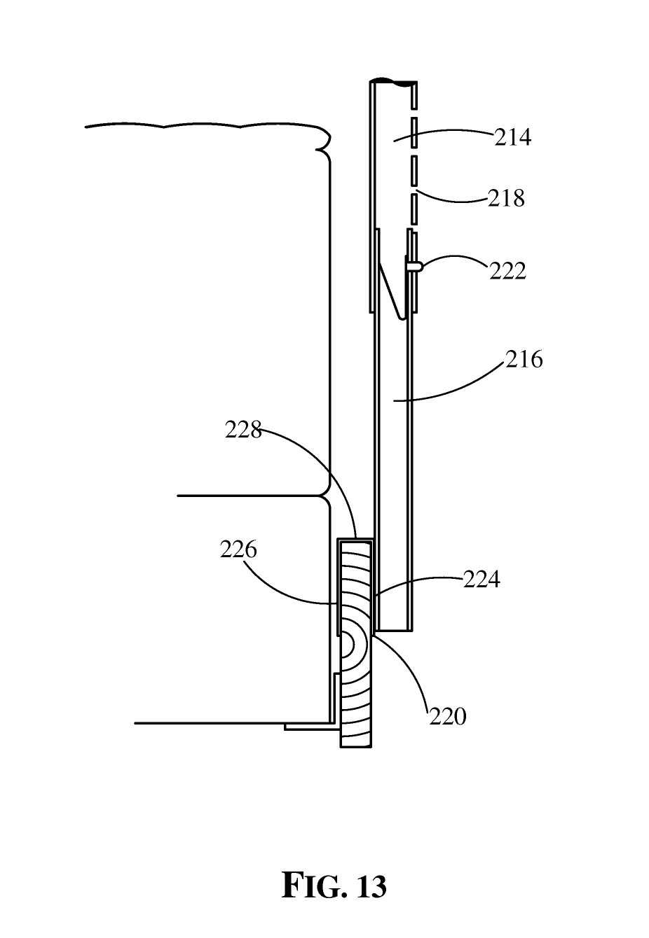

In further embodiments of the invention, the bed-mounted pet feeder of the invention may be mounted to a side rail of a bed. For example, FIGS. 11-13 show an illustrative embodiment of the invention, wherein a pet feeder having two pet dishes is mounted to the side rail of a bed. The feeder includes a top 210 having two apertures configured to accommodate two pet dishes 212. The top is attached to a telescopically adjustable stand having an upper stand section 214 and a lower stand section 216. The upper and lower stand sections each have one or more apertures 218. The apertures in the upper and the lower stand portions are positioned and oriented with one another so that they can align as the upper stand section is raised or lowered. A snap button 222 is fit in the lower stand section so that the stand can be locked at a chosen height.

The lower stand section 216 is attached to a bracket 220 that is configured to sit on top of a side rail of a bed. The bracket 220 comprises a first vertical face 224, an upper horizontal face 228, and a second vertical face 226. The bracket 220 is configured so that the horizontal faces 224 and 226 are of sufficient depth and width to stably anchor the pet feeder to the bed. As one will readily appreciate, the feeder can also readily be constructed with a single bracket 220 attached to a single stand sections 214, instead of the two shown, in a manner analogous to that exemplified in FIGS. 1-6. In such an embodiment, the bracket 220 is preferably at least about half the width of the top 210 and more preferably at least about the same width as the top 210 or more, since a single wider bracket provides greater stability to the pet dish than does a single narrower bracket. Although not shown, shims and/or an adjustable clamping mechanism may also be included in the bracket 220, so as to accommodate differing side rail thicknesses.

According to other embodiments of the invention, the bed-mounted pet feeder of the invention may have a semi-universal bed mount. As noted above, bed frames come in a variety of forms. Thus, according to certain embodiments of the bed-mounted pet feeder of the invention, the base is configured to accommodate a variety of different brackets and bracket configurations.

For example, as shown in FIGS. 14-16, a removable and reversible bracket for mounting to a bed frame 346 may be attached to the base 316. (For clarity, only the lower portion of the bed-mounted pet feeder, from the lower section of the stand 314 down is shown.) The reversible bed frame mounting bracket comprises an outer bracket 318 and inner bracket 320. The inner bracket and the outer bracket each comprise a horizontal portion (338 and 344, respectively) and a vertical portion (340 and 342, respectively).

The outer bracket 318 and the inner bracket 320 are configured to be bolted together with the L-shaped frame of a bed 346 in between, via nut and bolt combinations 328 and 330 and 334 and 332. Bolts pass through aligned apertures, 324 and 326 in the inner and outer brackets, respectively.

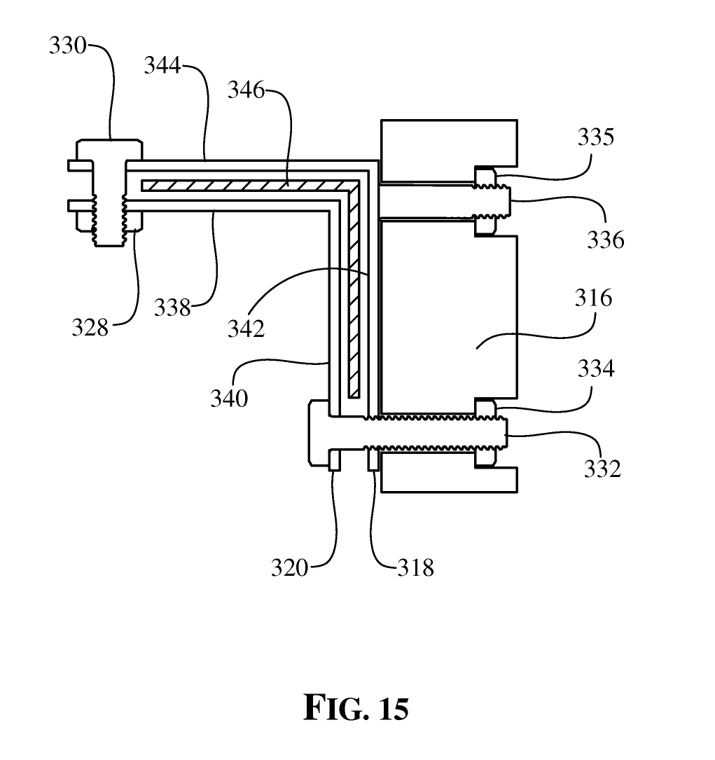

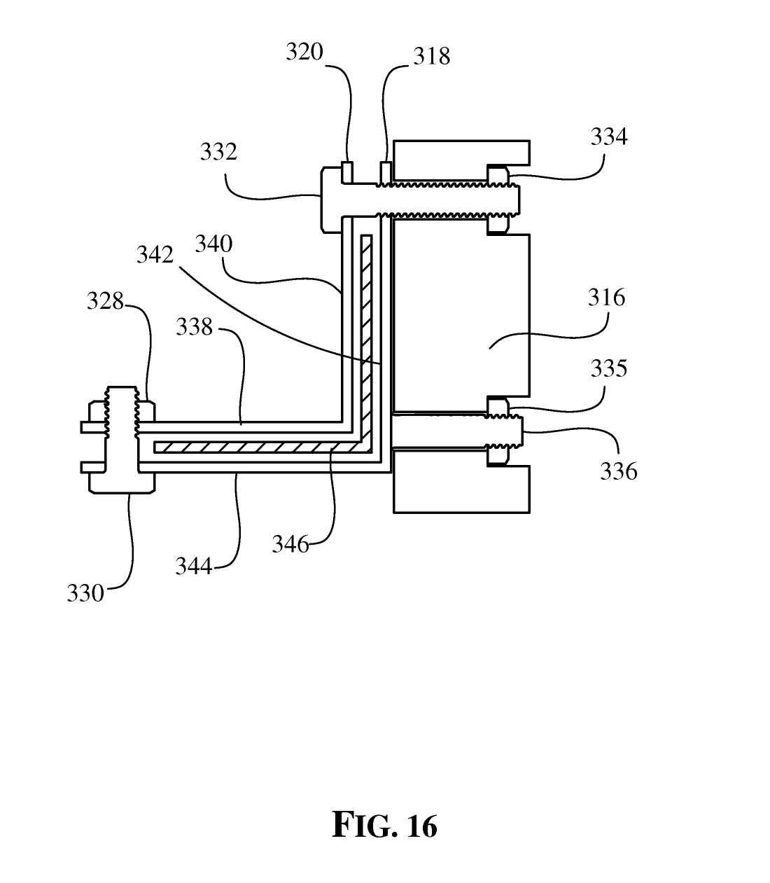

The vertical portion of the outer bracket 342 is configured to be attached to the base 316 via bolt 332, attached threaded shaft 336, and nuts 334 and 335. The base 316 comprises apertures 322 that align with the position of the threaded shaft 336 and the apertures in the vertical faces of the inner and outer brackets Inner bracket 320 and outer bracket 318 may be attached to base 316 in either of two orientations, depicted in FIGS. 15 and 16 respectively, depending on the configuration of the bed frame that the bed-mounted pet feeder is being mounted onto.

In an alternate embodiment, the bed rail mounting bracket depicted in FIGS. 11-13 may also be configured with threaded shafts to provide an additional side-rail mounting option for a semi-universal bed mount.

In other embodiments, the bed-mounted pet feeder contains a multi-function base capable of being mounted on more than one portion of a bed. For example, in FIGS. 17-19, a base configured to mount to either a bed frame or side rail is shown. The base includes a first horizontal section 424 that extends outward from the main body of the base 416. The first horizontal section 424 is attached to a vertical section 420 that extends downwards from the horizontal section. Together, the vertical section 420, the first horizontally extending section 424, and the main body of the base 416 define a channel 426 that is of sufficient width to fit over a standard side rail of a bed. The vertically extending section 420 is narrow in thickness, relative to the width of the channel 426, and is configured to be able to fit in the space between the vertical portion of a metal bed frame and the side of a mattress or box spring that is sitting on the bed frame. The base further includes a second horizontally extending section 418. This second horizontal section is attached to the lower end of vertical section 420, extending outward away from the main body of the base. The second horizontal section 418 is generally configured to fit on top of the horizontal portion of a bed frame, between the frame and a mattress or box spring.

The base further includes a tensioning thumb screw 422 that passes though the main body of the base 416 and extends generally horizontally into channel 426. Thumb screw 422 is of sufficient length to be able to tighten against the vertical portion of a metal bed frame inserted into channel 426.

The overall dimensions of the multi-function base may be about 4⅞ inches high, 7½ inches wide, and 5¾ inches deep. Channel 426 may be about 1¼ inches deep and about 4⅛ inches high. The second horizontally extending section 418 may be about 2 inches deep, which then leaves 2½ inches of depth for the remainder of the main body of the base 416. Vertical section 420 and the second horizontally extending section 418 are each about ⅛ inch thick. The lower stand section 414 is about 1⅜ inches in diameter and is inserted 4½ inches into the main body of the base 416.

In use, when the base is mounted onto the side rail of a bed, the side rail sits within channel 426 such that the top of the side rail rests against the lower surface of the first horizontal section 424. Vertical section 420 sits alongside the inner face of the side rail and the main body of the base sits alongside the outer face of the side rail. Tensioning screw 422 is tightened, securing the base to the side rail. When secured thusly to a side rail, the second horizontal section 418 merely extends into the space between the side rail and the box spring or mattress and does not, in of itself, provide substantial support.

In contrast, when the base is mounted onto the frame of a bed, the base sits with the second horizontal section 418 resting on top of the horizontal portion of the metal bed frame. The vertical portion of the bed frame then sits partially into channel 426, against the inner face of vertical section 420. Tensioning screw 422 is then tightened to fill the remaining space across channel 426, securing the base to the bed frame.

Detailed example embodiments have been disclosed herein. However, unless otherwise noted, specific structural and functional details disclosed herein are merely representative and provided for the purpose of describing the invention more clearly. It should be understood that there is no intent to limit the invention to any of the specific illustrative embodiments disclosed. It should also be understood that dimensions and relative proportions are not intended as limitations, unless expressly stated otherwise. Thus, it will be further understood from the foregoing, that various modifications and changes may be made to the various embodiments disclosed and described herein without departing from the spirit of the invention.

It will also be understood that when an element is referred to as being “connected” or “coupled” to another element, it may be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between”, “adjacent” versus “directly adjacent”, etc.).

As used herein, the singular forms “a”, “an” and “the” are intended to include the plural forms as well, unless the context clearly indicates otherwise. The term “and/or” includes any and all combinations of one or more of the associated listed items.

1. A bed-mounted pet feeder comprising: a top, an adjustable stand, and a base;
a. the top being largely horizontal in overall profile and having an upper surface and a lower surface, said upper surface having a bowl region;
b. the adjustable stand having an upper end and a lower end, said upper end being attached to said top and said lower end being attached to said base;
c. said adjustable stand further having an upper stand section, a lower stand section, and a fastening mechanism, said upper stand section and said lower stand section being telescopically connected, wherein said fastening mechanism is capable of maintaining said adjustable stand at a chosen height;
d. the base being capable of securely mounting to a region of a human bed selected from the group consisting of bed frame, side rail, bed post, and box spring.

2. The bed-mounted pet-feeder of claim 1, further comprising a pet dish.

3. (canceled)

4. The bed-mounted pet feeder of claim 1, wherein said top is rotatably attached to said adjustable stand.

5. The bed-mounted pet feeder of claim 1, wherein said top has a plurality of bowl regions.

6. The bed-mounted pet feeder of claim 1, wherein said fastening mechanism is a fastening mechanism selected from the group consisting of compression fitting, clamp, screw, bolt, peg, snap button, quick-release button connector, pin, pull pins, linch pin, clevis pin, gravity pin, and locking pin.

7. The bed-mounted pet feeder of claim 1, wherein said bowl region comprises an aperture running from the upper surface of the top through to the bottom surface of the top, said aperture capable of holding a pet dish.

8. (canceled)

9. The bed-mounted pet feeder of claim 1, wherein the bowl region comprises a recess, said recess dividing the top surface into a raised peripheral region and a recessed central region, wherein said recessed central region is able to contain a pet dish.

10. The bed-mounted pet feeder of claim 1, wherein the base comprises a clamp, said clamp being capable of mounting said base to a bed frame.

11. The bed-mounted pet feeder of claim 10, wherein the base comprises a vertical portion and a horizontal portion, said vertical portion defining a channel able to fit over a vertical portion of a bed frame, and said horizontal portion able to fit over a horizontal portion of a bed frame.

12. (canceled)

13. (canceled)

14. The bed-mounted pet feeder of claim 1, wherein the base comprises a bracket capable of mounting to a side rail of a bed, said bracket comprising an outer vertical face, an upper horizontal face, and an inner vertical face.

15. (canceled)

16. The bed-mounted pet feeder of claim 1, wherein said base includes a main body, a first horizontal section, and a vertical section, said first horizontal section extending outward from the main body of the base, said vertical section being attached to the first horizontal section and extending downwards, said vertical section, said first horizontal section, and said main body of the base defining a channel.

17. The bed-mounted pet feeder of claim 16, wherein said base further comprises a second horizontal section, said second horizontal section being attached to the vertical section of the base at a lower end and extending outward away from the main body of the base, said vertical section and said second horizontal section capable of fitting between a metal bed frame and the side of a mattress or box spring.

18. The bed-mounted pet feeder of claim 17, said channel being of sufficient width to fit over a standard side rail of a bed.

19. The bed-mounted pet feeder of claim 17, said channel being of sufficient width to fit over a vertical portion of a metal bed frame.

20. The bed-mounted pet feeder of claim 18, wherein said main body of the base further comprises a tensioning screw, said tensioning screw passing generally horizontally through said main body of the base and into said channel and capable of tightening said base onto a bed frame or side rail.
